(19) United States
(12) Patent Application Publication
(10) Pub. No.: US 2017/0132897 A1
(43) Pub. Date: May 11, 2017

(54) COMPUTER-IMPLEMENTED METHODS AND SYSTEMS FOR MONITORING SUBJECTS

(71) Applicant: BabyBit, Inc., .Portland, OR (US)

(72) Inventor: Brian Ostrovsky, Portland, OR (US)

(73) Assignee: BabyBit, Inc., Portland, OR (US)

(21) Appl. No.: 15/336,205

(22) Filed: Oct. 27, 2016

Related U.S. Application Data
(60) Provisional application No. 62/252,826, filed on Nov. 9, 2015.

(51) Int. Cl. G08B 21/02; H04W 4/00; H04W 4/02; H04B 17/318

(52) U.S. Cl. CPC G08B 21/0211; H04B 17/318; H04W 4/008; G08B 21/0266; H04W 4/02; G08B 21/0247; H04B 5/0031

(57) ABSTRACT

Computer-implemented methods and systems are disclosed for monitoring subjects such as people, animals, or objects, and automatically detecting and reporting particular conditions. For example, the systems and methods can be used for health and/or safety monitoring and reporting conditions such as, e.g., a health condition or an out-of-bounds condition.

### CROSS REFERENCE TO RELATED APPLICATION

This application claims priority from U.S. Provisional Patent Application No. 62/252,826 filed on Nov. 9, 2015 entitled COMPUTER-IMPLEMENTED METHODS AND SYSTEMS FOR MONITORING SUBJECTS, which is hereby incorporated by reference.

### BACKGROUND

The present application relates generally to computer-implemented methods and systems for monitoring subjects such as people, animals, or objects, and automatically detecting and reporting particular conditions.

### BRIEF SUMMARY OF THE DISCLOSURE

A computer-implemented method in accordance with one or more embodiments for remotely monitoring a subject, comprises the steps, performed by a cloud database and management system, of: (a) receiving sensor data about the subject and connection data over a computer network from a portable first computer device, said first computer device receiving the sensor data from a sensor device monitoring the subject, said connection data providing information on a wireless communication connection between the first computer device and the sensor device; (b) transmitting the sensor data and the connection data over the computer network to a second computer device; and (c) when a given condition occurs involving sensor device or the first computer device, automatically detecting the condition and reporting the condition to the second computer device and/or the first computer device over the computer network.

A computer system in accordance with one or more embodiments comprises at least one processor; memory associated with the at least one processor; and a program supported in the memory for remotely monitoring a subject. The program contains a plurality of instructions which, when executed by the at least one processor, cause the at least one processor to: (a) receive sensor data about the subject and connection data over a computer network from a first computer device, said first computer device receiving the sensor data from a sensor device on the subject, said connection data providing information on a wireless connection between the first computer device and the sensor device; (b) transmit the sensor data and the connection data over the computer network to a second computer device; and (c) when a given condition occurs involving sensor device or the first computer device, automatically detect the condition and report the condition to the second computer device and/or the first computer device over the computer network.

A computer system for remotely monitoring a plurality of subjects in accordance with one or more embodiments comprises a plurality of sensor devices, each on a subject to be monitored; and a cloud database and management system. For each subject, the cloud database and management system is configured to (a) receive sensor data about the subject and connection data over a computer network from a first computer device, said first computer device receiving the sensor data from one of said sensor devices on the subject, said connection data providing information on a wireless connection between the first computer device and the sensor device; (b) transmit the sensor data and the connection data over the computer network to a second computer device; and (c) when a given condition occurs involving sensor device or the first computer device, automatically detecting the condition and reporting the condition to the second computer device and/or the first computer device over the computer network.

### BRIEF DESCRIPTION OF THE DRAWINGS

FIG. 1 is a simplified diagram illustrating operation of an exemplary monitoring system in accordance with one or more embodiments.

FIGS. 2-4 are diagrams illustrating various problems that may arise during operation of the monitoring system.

FIGS. 5-8 are diagrams illustrating solutions to problems identified in FIGS. 2-4 in accordance with one or more embodiments.

FIG. 9 is a simplified diagram illustrating use of the monitoring system for monitoring a baby in accordance with one or more embodiments.

Like or identical reference numbers are used to identify common or similar elements.

### DETAILED DESCRIPTION

The present application relates generally to computer-implemented methods and systems for monitoring subjects such as people, animals, or objects, and automatically detecting and reporting particular conditions. For example, the systems and methods can be used for health and/or safety monitoring and reporting conditions such as, e.g., a health condition or an out-of-bounds condition.

The methods and systems can have a wide variety of applications including, but not limited to, child monitoring, eldercare monitoring, pet monitoring, low level prisoner monitoring, and employee monitoring. In the child monitoring example, the methods and systems can be used by a parent or other primary caregiver to remotely monitor their child as the child is being cared for by a secondary caregiver such as, e.g., a nanny, grandmother, or day care worker.

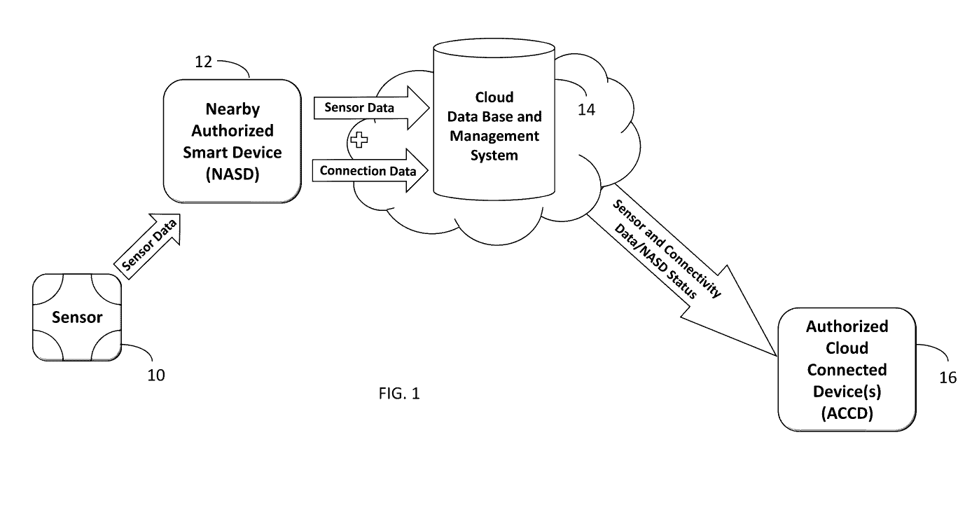

FIG. 1 is a simplified diagram illustrating operation of an exemplary monitoring system in accordance with one or more embodiments. A sensor device 10 monitoring the child is attached to the child or an item of clothing worn by the child. The sensor device 10 sends data about the child to a smartphone or other computer device (referred to herein as a “Nearby Authorized Smart Device” or “NASD”) 12 operated by a nearby secondary caregiver via an application running on the NASD 12. The NASD 12 monitors the connection between the sensor device 10 and itself. The NASD 12 transmits sensor and connection data to a cloud database and management system 14 via an application running on the NASD 12. The cloud database and management system 14 processes and transmits both the sensor and connection data to a smartphone or other computer device (referred to herein as an “Authorized Cloud Connected Device” or “ACCD”) 16 operated by the parent or other primary caregiver. In this way, the parent or other primary caregiver can quickly and easily obtain information on the child remotely, including information on the proximity of the child to a caregiver or caregiver location, child status, and/or general health and well-being information.

As shown in FIG. 1, the NASD 12 receives data from a sensor 10 and monitors the connection between the sensor 10 and itself.

The NASD 12 (1) confirms an authorized connection with the sensor 10, (2) provides an identification of the specific device that is connected to the sensor 10, (3) identifies the signal strength of connection between sensor 10 and NASD 12, (4) identifies the duration of the connection between sensor 10 and NASD 12, (5) identifies the proximity or distance between sensor 10 and NASD 12, and (6) reports the physical location of the NASD 12.

NASDs 12 are usually smart phones, but could also be a tablet computer, a wearable computer device (e.g., a smart watch and smart glasses), a cell phone, a personal digital assistant, and generally any computer device that can communicate with the sensor device 10 and the cloud database and management system 14. A NASD 12 includes at least one computer processor and a storage medium readable by the processor for storing applications and data.

The sensor 10 comprises a portable hardware module configured to monitor a subject. This portable module can comprise a printed circuit board (PCB) within a housing. The PCB includes an onboard central processing unit (CPU) and various components on it that monitor the behavior and condition of the subject (e.g., the body temperature or heart rate of a person). The sensor 10 may also monitor the environmental conditions that the subject is in (e.g., room temperature and noise levels).

The sensor 10 processes collected data from the subject via the CPU. It then packages the data for transmission to the NASD 12. In one or more embodiments, the sensor 10 transmits the data to the NASD 12 using Bluetooth Low Energy Technology. A variety of other communication technologies can also be used including, but not limited to, Near field communication (NFC), Cellular telephone network technology, home wireless technology (WiFi), etc.

The NASD 12 transmits both the subject sensor and connection data to the cloud database and management system 14 via an application running on the NASD 12. The cloud database and management system 14 then transmits both the subject and connection data to any other device(s) (referred to herein as “Authorized Cloud Connected Devices” or “ACCDs”) 16 that is/are authorized to connect to the cloud database to receive data collected from the sensor device 10. ACCD(s) 16 can receive this data from the cloud database and management system 14 as long as they are connected to the internet, regardless of where they are in the world.

The ACCDs 16 operated by users to access the cloud database can comprise any computing device that can communicate with the cloud database and management system 14 including, without limitation, personal computers (including desktop, notebook, and tablet computers), smart phones (e.g., the Apple iPhone and Android-based smart phones), wearable computer devices (e.g., smart watches and smart glasses), cell phones, and personal digital assistants.

The cloud database and management system 14 can comprise a computer server or network of servers hosted on the Internet adapted to remotely store, manage, and process data.

The NASDs 12 and ACCDs 16 communicate with the cloud database and management system 14 over a communications network. The communications network may comprise any network or combination of networks including, without limitation, the Internet, a local area network, a wide area network, a wireless network, and a cellular network.

Monitoring systems in accordance with one or more embodiments address various problems identified below that may arise during operation.

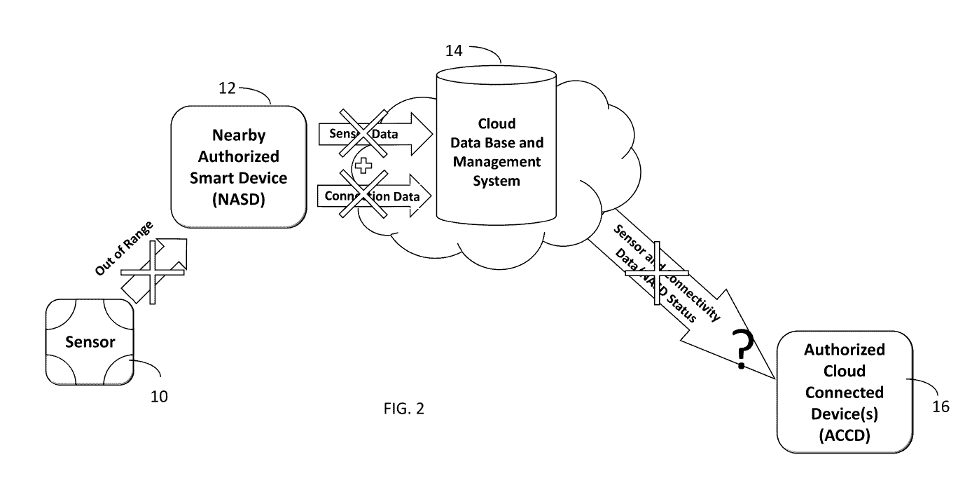

Problem 1: As illustrated in FIG. 2, if the sensor 10 goes out of the range of the NASD 12, the NASD 12 stops updating the cloud database—a “Sensor Disconnection” condition. The ACCD 16 then stops receiving sensor and connection data from the cloud database 14. The ACCD 16 cannot receive information regarding the circumstances of the Sensor Disconnection. Specifically, the ACCD 16 does not have information on the location of sensor disconnection, the time of sensor disconnection, or the last known NASD.

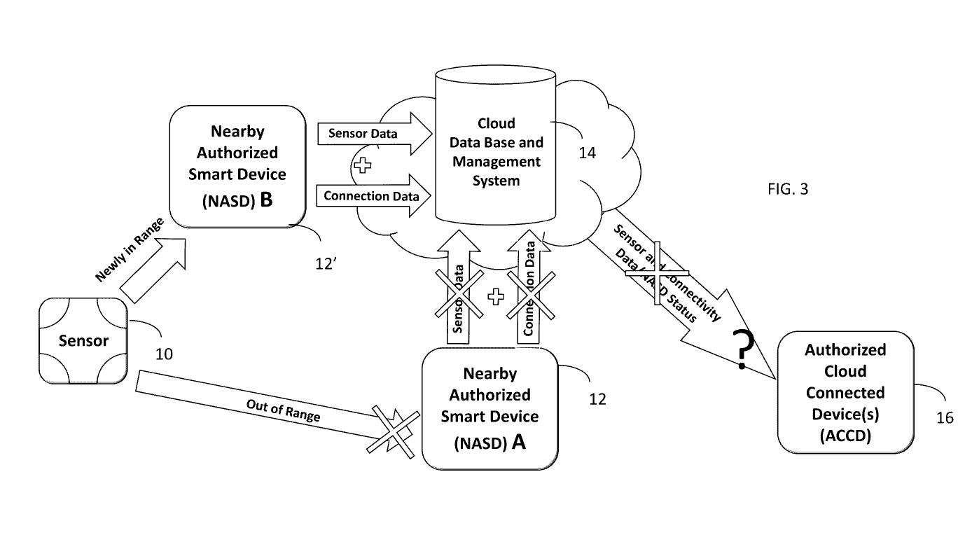

Problem 2: As illustrated in FIG. 3, the connection between a NASD 12 and the sensor 10 can change. Specifically, the NASD 12 operated by person A loses connection to the sensor 10, but the connection is re-established between the sensor 10 and NASD 12′ of person B. The ACCD 16 will not know that this change in connection between the sensor 10 and the NASD 12 of person A and the sensor 10 and the NASD 12′ of person B (known as a “Transfer of Sensor Connection”) has occurred. Therefore, the ACCD 16 remains disconnected and unable to receive data.

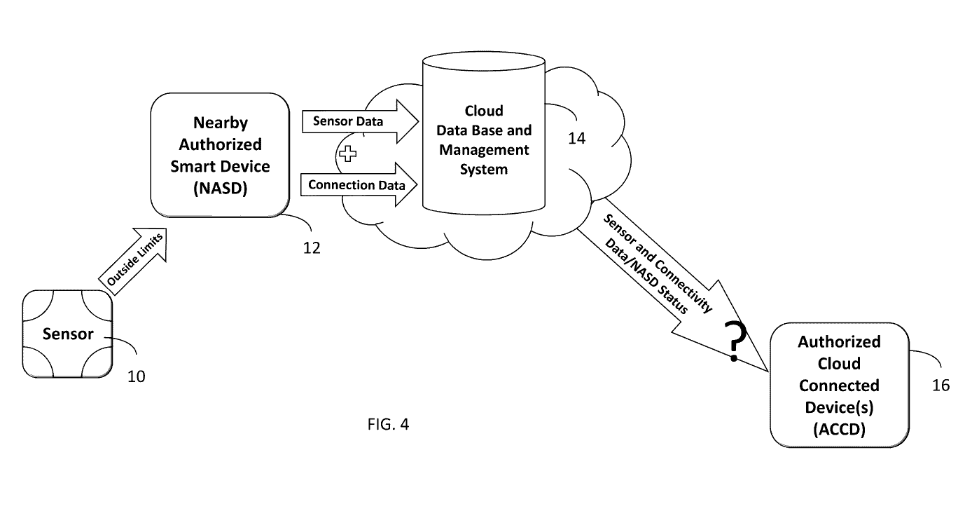

Problem 3: As shown in FIG. 4, the NASD 12 is transmitting sensor or connection data to the cloud database 14 that is outside of preset limits, as defined by ACCD preferences or developer preferences. The ACCD 16 should be notified this data is outside of preset limits, without actively and constantly monitoring the data on the device 16. Note that this example shows sensor data outside preset limits, but connectivity conditions/data could also be outside these limits.

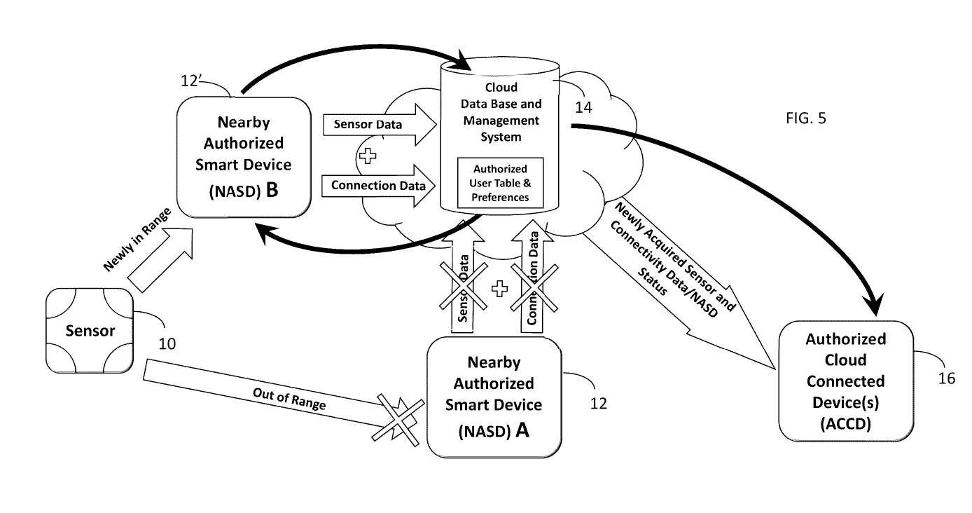

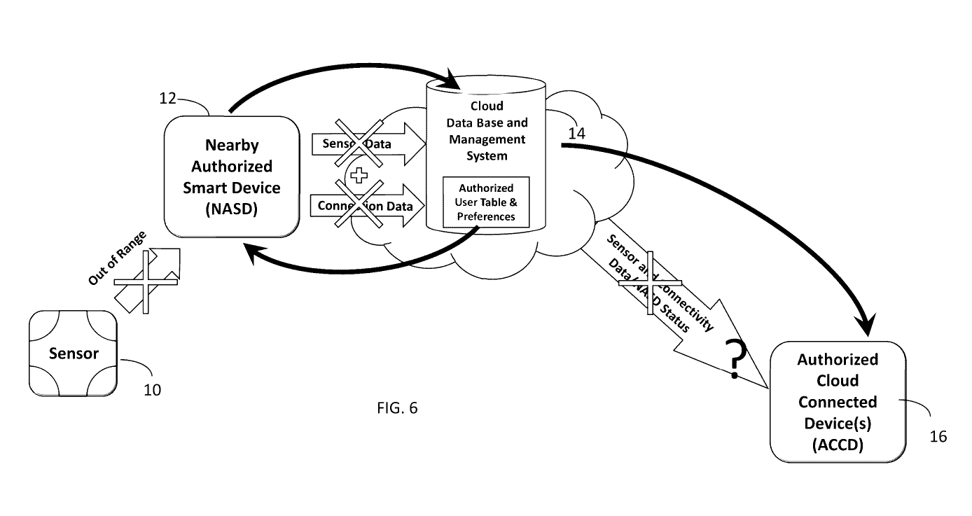

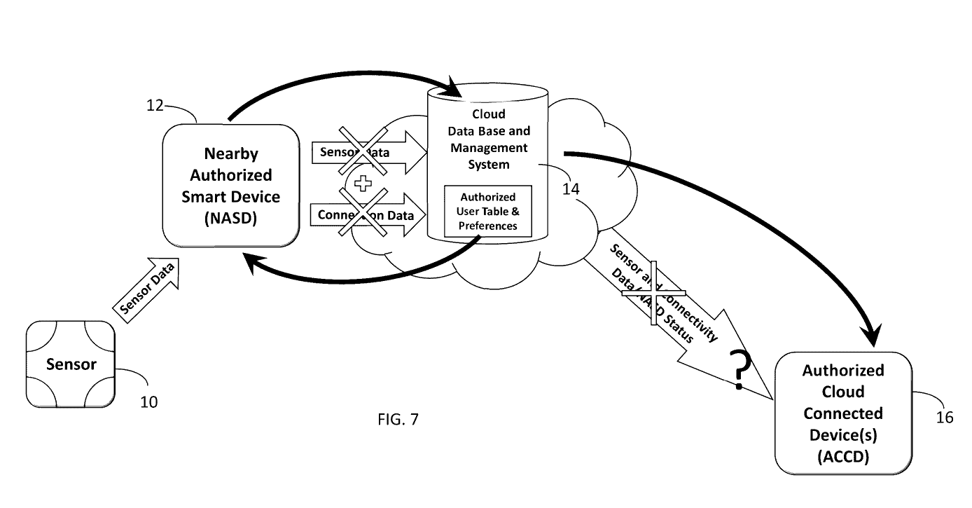

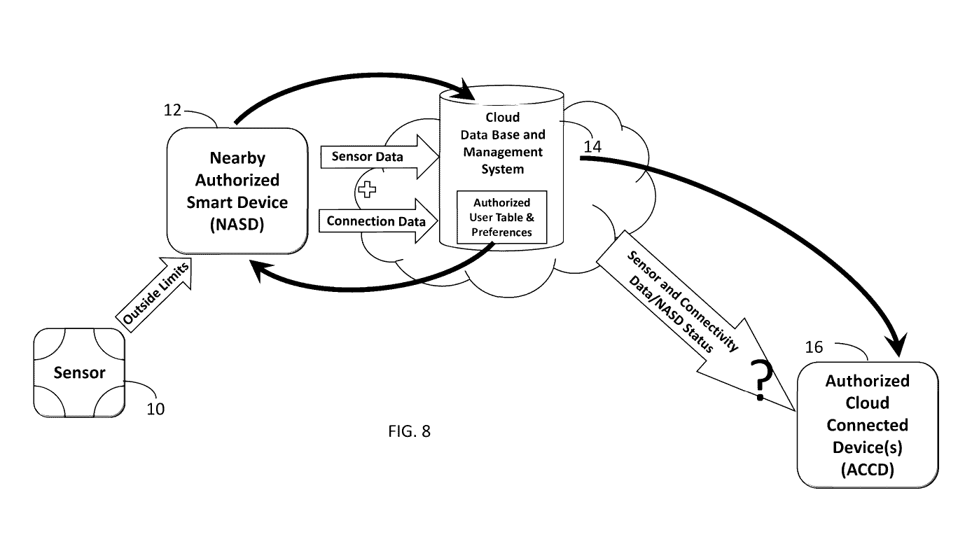

A monitoring system in accordance with one or more embodiments addresses the above identified problems. As illustrated in FIGS. 5-8, the cloud database and management system 14 is configured to enable the cloud database to automatically, without direct human action or intervention, provide status update messages to the ACCD(s) 16 if any of the situations illustrated in FIGS. 2-4 is occurring or has occurred: (1) The NASD 12 that is connected to the sensor monitoring subject has changed to a different NASD connected to the sensor monitoring subject (referred to herein as a Transfer of Connectivity as shown in FIG. 5). (2) The NASD 12 is not connected to the sensor monitoring subject (referred to herein as Sensor Disconnection as shown in FIG. 6). (3) The NASD 12 is not connected to and/or is not sending updates to the cloud database and management system 14 as shown in FIG. 7. (4) The NASD 12 is transmitting data that is outside of preset limits, as defined by ACCD preferences or developer preferences as shown in FIG. 8.

As shown in FIGS. 5-8, the cloud database and management system 14 addresses situations (1)-(3) above, by maintaining communications with the NASD 12 and the ACCD(s) 16. The cloud database and management system 14 is programmed to expect to receive regularly timed updates from the NASD 12, and those updates are anticipated to be within preset limits. If these updates are not received from the NASD 12, or they are received within the expected timeframe, but are not within preset limits, then a message is sent from the cloud database and management system 14 to either the NASD 12, or the ACCD(s) 16, or both. These messages can be adjusted for message type, frequency of delivery or timeframe between messages, also based on the settings as defined by ACCD preferences or developer preferences.

Through this innovative capability, no matter where an ACCD 16 is in the world, as long as it is connected to the internet, it will automatically, without direct human action or intervention, know which NASD 12 is nearby to the sensor, that it is connected to the sensor, how close it is to the sensor, and that all sensor data and connectivity data is within preset limits.

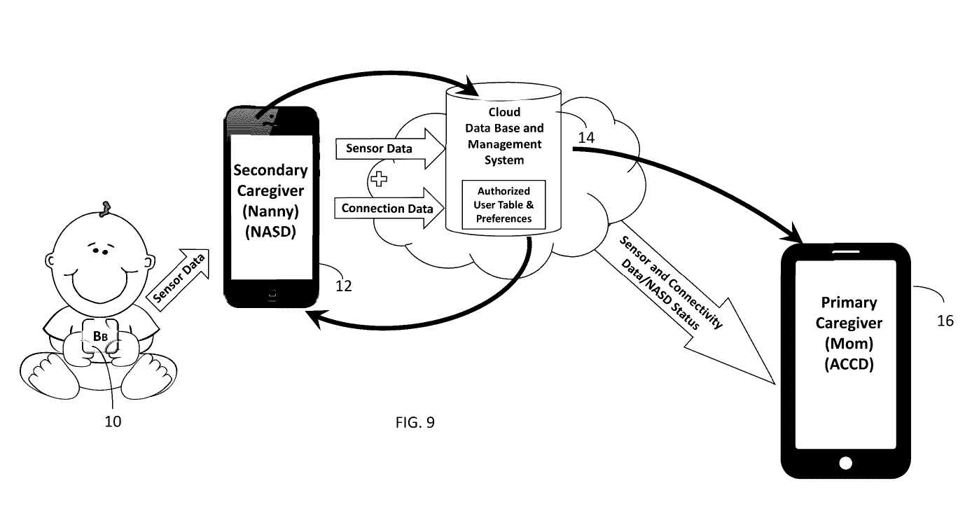

FIG. 9 illustrates exemplary use of the monitoring system for monitoring a baby. A sensor 10 is attached to a baby's clothing. The Secondary Caregiver watching the baby has a NASD 12 that is connected to the sensor 10 via an application installed and running on the NASD 12. The application is also connected to the cloud database and management system 14. The cloud database and management system 14 is also connected to the Primary Caregiver (that is often not with the baby) operating an ACCD 16.

The solution described above allows the Primary Caregiver (e.g., a mother or father) to know: (a) who is taking care of the baby (NASD data), (b) how close they are to the baby (NASD data), (c) the physical location of the baby and Secondary Caregiver (NASD data), and (d) how the baby is doing (sensor data). If anything changes in (a)-(d), outside of preset limits/conditions, or is interrupted and not corrected, within a preset timeframe, then automatic notifications are sent alerting the Primary Caregiver to the out of bound condition or situation, allowing timely intervention to address the situation.

These capabilities work regardless of where the baby and Secondary Caregiver is located, or where the Primary caregiver is located, as long as the Secondary Caregiver(s) and Primary Caregiver are using internet or other network connected devices such as smart mobile devices.

The processes of the monitoring system described above may be implemented in software, hardware, firmware, or any combination thereof. The processes are preferably implemented in computer programs executing on programmable computers, each including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer server system may comprise one or more physical machines, or virtual machines running on one or more physical machines. In addition, the computer server system may comprise a cluster of computers or numerous distributed computers that are connected by the Internet or another network.

Accordingly, the foregoing description and attached drawings are by way of example only, and are not intended to be limiting.

What is claimed is:

1. A computer-implemented method of remotely monitoring a subject, comprising the steps, performed by a cloud database and management system, of:
(a) receiving sensor data about the subject and connection data over a computer network from a first computer device, said first computer device receiving the sensor data from a sensor device on the subject, said connection data providing information on a wireless connection between the first computer device and the sensor device;
(b) transmitting the sensor data and the connection data over the computer network to a second computer device; and
(c) when a given condition occurs involving sensor device or the first computer device, automatically detecting the condition and reporting the condition to the second computer device and/or the first computer device over the computer network.

2. The method of claim 1, wherein the subject is a person, an animal, or an object.

3. The method of claim 1, wherein the given condition comprises a health condition of the subject detected by the sensor device, or an out of bounds condition of the first computer device or the sensor device.

4. The method of claim 1, wherein the subject is a child, the first computer device is operated by a secondary caregiver, and the second computer device is operated by a primary caregiver, and wherein the sensor data includes information on the proximity of the child to the secondary caregiver, a location of the secondary caregiver, child status, and/or child health information.

5. The method of claim 1, wherein the connection data received from the first computer device includes a confirmation of an authorized connection with the sensor device, an identification of the first computer device, information on the signal strength of the wireless connection between the first computer device and the sensor device, information on the duration of the wireless connection between the sensor device and the first computer device, information on the proximity between the sensor device and the first computer device, and information on the physical location of the first computer device.

6. The method of claim 1, wherein the first computer device and the second computer device comprise smart phones, tablet computers, or wearable computers.

7. The method of claim 1, wherein the sensor device communicates with first computer device using Bluetooth, near field communications, cellular network, or WiFi technology.

8. The method of claim 1, wherein the given condition comprises a sensor disconnection condition, a transfer of sensor condition, or a data outside preset limits condition.

9. The method of claim 1, wherein the sensor device comprises a portable hardware module configured to monitor the subject, the portable module including a central processing unit (CPU) and one or more components to monitor a behavior and/or a condition of the subject.

10. The method of claim 1, wherein the sensor device measures a body temperature or heart rate of the subject or monitors environmental conditions experienced by the subject.

11. A computer system, comprising:
at least one processor;
memory associated with the at least one processor; and
a program supported in the memory for remotely monitoring a subject, the program containing a plurality of instructions which, when executed by the at least one processor, cause the at least one processor to:
(a) receive sensor data about the subject and connection data over a computer network from a first computer device, said first computer device receiving the sensor data from a sensor device on the subject, said connection data providing information on a wireless connection between the first computer device and the sensor device;
(b) transmit the sensor data and the connection data over the computer network to a second computer device; and
(c) when a given condition occurs involving sensor device or the first computer device, automatically detect the condition and report the condition to the second computer device and/or the first computer device over the computer network.

12. The system of claim 11, wherein the given condition comprises a health condition of the subject detected by the sensor device, or an out of bounds condition of the first computer device or the sensor device.

13. The system of claim 11, wherein the subject is a child, the first computer device is operated by a secondary caregiver, and the second computer device is operated by a primary caregiver, and wherein the sensor data includes information on the proximity of the child to the secondary caregiver, a location of the secondary caregiver, child status, and/or child health information.

14. The system of claim 11, wherein the connection data received from the first computer device includes a confirmation of an authorized connection with the sensor device, an identification of the first computer device, information on the signal strength of the wireless connection between the first computer device and the sensor device, information on the duration of the wireless connection between the sensor device and the first computer device, information on the proximity between the sensor device and the first computer device, and information on the physical location of the first computer device.

15. The system of claim 11, wherein the first computer device and the second computer device comprise smart phones, tablet computers, or wearable computers.

16. The system of claim 11, wherein the sensor device communicates with first computer device using Bluetooth, near field communications, cellular network, or WiFi technology.

17. The system of claim 11, wherein the given condition comprises a sensor disconnection condition, a transfer of sensor condition, or a data outside preset limits condition.

18. The system of claim 11, wherein the sensor device comprises a portable hardware module configured to monitor the subject, the portable module including a central processing unit (CPU) and one or more components to monitor a behavior and/or a condition of the subject.

19. The system of claim 11, wherein the sensor device measures a body temperature or heart rate of the subject or monitors environmental conditions experienced by the subject.

20. A computer system for remotely monitoring a plurality of subjects, comprising:
a plurality of sensor devices, each on a subject to be monitored; and
a cloud database and management system configured to, for each subject:
(a) receive sensor data about the subject and connection data over a computer network from a first computer device, said first computer device receiving the sensor data from one of said sensor devices on the subject, said connection data providing information on a wireless connection between the first computer device and the sensor device;
(b) transmit the sensor data and the connection data over the computer network to a second computer device; and
(c) when a given condition occurs involving sensor device or the first computer device, automatically detecting the condition and reporting the condition to the second computer device and/or the first computer device over the computer network.
